(19) United States
(12) Patent Application Publication
(10) Pub. No.: US 2023/0401705 A1
(43) Pub. Date: Dec. 14, 2023

(54) Systems and Methods for Ground Truthing Remotely Sensed Data

(71) Applicant: The Regents of the University of California, Oakland, CA (US)

(72) Inventor: Lorna KABACHNIK, Cherry Hill, NJ (US)

(73) Assignee: The Regents of the University of California, Oakland, CA (US)

(21) Appl. No.: 18/252,169

(22) PCT Filed: Nov. 9, 2021
(86) PCT No.: PCT/US2021/072310

§ 371 Date: May 8, 2023

Related U.S. Application Data
(60) Provisional application No. 63/111,344, filed on Nov. 9, 2020.

(51) Int. Cl. G06T 7/00; G06T 17/10; G06T 7/543; G06T 7/62

(52) U.S. Cl. CPC G06T 7/0012; G06T 17/10; G06T 7/543; G06T 7/62; G06T 2207/30188; G06T 2207/10032; G06T 2207/30004

(57) ABSTRACT

Systems and methods for tree census collection are provided. Many embodiments provide improvements to tree modeling, including dimensions of tree crowns, which provides greater accuracy in tree modeling. Furthermore, the improvements to tree modeling provide in-situ datasets to ground truth high resolution satellite imagery, LiDAR, and other remotely sensed products and models. The method may also be used to model and ground truth other remotely sensed phenomena having irregular shapes, such as nebula, vapor plumes, volcanic eruptions, cloud cover, sea cover, on Earth, other planetary bodies, or elsewhere in space, and for improved modeling of remotely sensed physical phenomena from data collected from satellites, embedded sensors, telescopes and other astrophotography systems.

### CROSS-REFERENCE TO RELATED APPLICATIONS

This application is a U.S. National Stage of PCT Application Ser. No. PCT/US2021/072310, entitled “Systems and Methods for Ground Truthing Remotely Sensed Data”, to Lorna Kabachnik, filed Nov. 9, 2021, which claims priority to U.S. Provisional Application Ser. No. 63/111,344, entitled “Systems and Methods for Tree Census Collection” to Lorna Kabachnik, filed Nov. 9, 2020, the disclosures of which are incorporated herein by reference in their entireties.

### FIELD OF THE DISCLOSURE

The present disclosure relates to remote sensing, in particular methods and systems for ground truthing remotely sensed data for more accurate determinations of total canopy cover, canopy volume, above ground biomass, various types of spatial estimates on earth, and other irregularly shaped phenomena in space.

### BACKGROUND OF THE DISCLOSURE

Cities and governments around the world are seeking best practices in forest management to stabilize climate, mitigate natural disasters, protect human health and to bolster the long term biological security of our, water, soil, food, and habitat. (See e.g., Pincetl, 2010 Environmental management. 45(2):227-38; Dobbs et al, 2011 Landscape and Urban Planning, 99(3-4):196-206; Jonsson et al 2019 Nature Plants, (5):141-147; Vargas et al, 2019 Environmental Management. 63(1):1-15; and Arantes et al 2019 International Forestry Review, 21(2):167-181; the disclosures of which are hereby incorporated by reference in their entireties.) The established forests being lost around urbanizing areas are those most needed to provide habitat, clean water and air, recreation, and other ecosystem services to growing human populations and other species.

Additionally, many governments cannot afford to utilize GIS and Remote Sensing methodologies for ecosystem management due to a variety of reasons, including cost, infrastructure, lack of skilled analysts, and political instability. (See e.g., Mennecke and West, 2001 Journal of Global Information Management. 9(4):44-54; Jha and Chowdary 2007 Hydrogeology Journal, 15(1):197-202; Macauley and Richardson 2011 Berkeley Technology Law Journal, 26(3):1387-1408; Makanga et al 2016 The Canadian Geographer, 60(3):320-332; and Aggarwal 2018 Remote Sensing Technologies and Applications in Urban Environments III, Proc SPIE 10793; the disclosures of which are hereby incorporated by reference in their entireties.) The economic drivers advancing urban forestry are carbon sequestration and trading, heat island reduction, pollution mitigation, habitat conservation, biodiversity management, public health concerns, and the management of water, air, and soil.

Geospatial data sets are produced by governments and the private and non-profit sectors to model, monitor, calibrate, and monetize forests in urban centers around the world using traditional, high-tech, and open-source data collection. The current methods for modeling forests is outlined by the United States Department of Agriculture (USDA) through the Forest Health Monitoring Program. (See e.g., McRoberts et al. 2005 Journal of Forestry, 103(6):304-308; the disclosure of which is hereby incorporated by reference in its entirety.) The most common tree census models collect tree location, diameter at breast height (DBH), tree height, and tree species. These universal tree census data parameters are outdated, and the models based on them are insufficient to harmonize and assess the accuracy of, and ground-truth remotely sensed data sets used to manage natural resources. More specifically the outdated traditional tree census parameters are insufficient to provide in-situ derived estimates for use in ground-truthing models for total canopy cover and canopy volume above ground biomass derived from remotely sensed data sets.

### SUMMARY OF THE DISCLOSURE

This summary is meant to provide examples and is not intended to be limiting of the scope of the invention in any way. For example, any feature included in an example of this summary is not required by the claims, unless the claims explicitly recite the feature.

In one embodiment, a method includes obtaining ground truth data for a reference parcel of land containing at least one tree, where the ground truth data includes geometric data for the at least one tree, where the geometric data characterizes the at least one tree by a custom shape, and ground truthing a remotely sensed dataset of the reference parcel of land by correlating the remotely sensed dataset with the ground truth data.

In a further embodiment, the method further includes generating the geometric data for the at least one tree by measuring at least one geometric attribute of the at least one tree.

In another embodiment, the at least one geometric attribute is selected from: tree height, crown base, diameter at breast height, ground, north canopy, east canopy, south canopy, and west canopy.

In a still further embodiment, the custom shape is a two-dimensional shape.

In still another embodiment, the two-dimensional shape is selected from a Kabachnik ellipse and a Kabachnik quadrilateral, where the Kabachnik ellipse is characterized by two perpendicular and intersecting axes, where each axis comprises two arms each extending from the intersection, where at least one arm has a different length than the other arms, and where the Kabachnik quadrilateral is characterized by two perpendicular and intersecting axes, where each axis comprises two arms each extending from the intersection, wherein at least one arm has a different length than the other arms.

In a yet further embodiment, the custom shape is a three-dimensional shape.

In yet another embodiment, the three-dimensional shape is selected from: a Kabachnik ellipsoid, a Kabachnik ellipsoid cone, a Kabachnik ellipsoid trapezium, and a Kabachnik ellipsoid cylinder.

In a further embodiment again, the method further includes obtaining the remotely sensed dataset.

In another embodiment again, the remotely sensed dataset is obtained via satellite imagery, airborne sensor data, airborne photography, photogrammetry, astrophotography, or LiDAR.

In a further additional embodiment, the remotely sensed dataset is a commercial product.

In another additional embodiment, the commercial product is Google Earth.

In a still yet further embodiment, the ground truth data is in-situ data for the reference parcel of land.

In still yet another embodiment, ground truthing generates a 2D construct of the reference parcel of land.

In a still further embodiment again, ground truthing generates a 3D construct of at least one tree in the reference parcel of land.

In still another embodiment again, ground truthing determines at least one metric selected from: biomass, leaf area index, and carbon storage.

In a still further additional embodiment, the method further includes monitoring a target parcel of land by: obtaining a second remotely sensed dataset, where the second remotely sensed dataset is obtained for the target parcel of land, and identifying a metric in the second parcel of land, where the metric is selected from: total canopy cover, biomass, leaf area index, and carbon storage.

In still another additional embodiment, the method further includes obtaining a third remotely sensed dataset, where the third remotely sensed dataset is obtained for the target parcel of land, where the third remotely sensed dataset is obtained at a different time than the remotely sensed dataset, and identifying a change in the target parcel of land.

In a yet further embodiment again, monitoring a target parcel of land further includes harmonizing the second remotely sensed dataset in two dimensions or three dimensions.

In yet another embodiment again, harmonizing includes at least one of regridding, fishnetting, rasterizing, and interpolating.

In a yet further additional embodiment, a method for harmonizing data for a remotely sensed phenomenon having an irregular shape includes obtaining at least one measurement of a remotely sensed phenomenon, and constructing a geometric model of the remotely sensed phenomenon based on the at least one measurement.

In yet another additional embodiment, the remotely sensed phenomenon is a tree and the at least one measurement is selected from: tree height, crown base, diameter at breast height, ground, north canopy, east canopy, south canopy, and west canopy.

In a further additional embodiment again, the geometric model is a two-dimensional model selected from: a Kabachnik ellipse and a Kabachnik quadrilateral, where the Kabachnik ellipse is characterized by two perpendicular and intersecting axes, where each axis comprises two arms each extending from the intersection, where at least one arm has a different length than the other arms, and where the Kabachnik quadrilateral is characterized by two perpendicular and intersecting axes, where each axis comprises two arms each extending from the intersection, where at least one arm has a different length than the other arms.

In another additional embodiment again, the geometric model is a three-dimensional model selected from: a Kabachnik ellipsoid, a Kabachnik ellipsoid cone, a Kabachnik ellipsoid trapezium, and a Kabachnik ellipsoid cylinder.

The foregoing and other objects, features, and advantages of the disclosed technology will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIGS. 1A-1C illustrate geometric modeling of tree in accordance with various embodiments of the invention.

FIG. 2 illustrates various tree canopy shapes in accordance with various embodiments of the invention.

FIG. 3 illustrates various geometric measurements of a tree in accordance with various embodiments of the invention.

FIGS. 4A-4E illustrate ellipses obtained from tree measurements in accordance with various embodiments of the invention.

FIG. 5A illustrates a quadrilateral model of a tree canopy in accordance with various embodiments of the invention.

FIG. 5B illustrates a ellipse model of a tree canopy in accordance with various embodiments of the invention.

FIGS. 6A-6E illustrate geometric models of tree canopies or stems in accordance with various embodiments of the invention.

FIG. 7A illustrates an overview of data harmonization in accordance with various embodiments of the invention.

FIGS. 7B-7C illustrate exemplary diagrams for data harmonization in accordance with various embodiments of the invention.

FIG. 7D illustrates a correlation of LiDAR data with tree data in accordance with various embodiments of the invention.

FIG. 8A illustrates a method for using remote sensing data in accordance with various embodiments of the invention.

FIG. 8B illustrates a block diagram of components of a computer system in accordance with an embodiment of the invention.

FIG. 8C illustrates a network diagram for systems for ground truthing remotely sensed data in accordance with various embodiments of the invention.

FIG. 9 illustrates an error matrix for remotely sensed image processing in accordance with various embodiments of the invention.

### DETAILED DESCRIPTION OF THE DISCLOSURE

Turning now to the diagrams and figures, embodiments herein are directed to systems and methods for tree census collection. Many embodiments provide improvements to tree modeling, including dimensions of tree crowns, which provides greater accuracy in tree modeling. Furthermore, the improvements to tree modeling provide datasets to harmonize and ground truth high resolution satellite imagery, LiDAR, and other remotely sensed products and models. The systems and methods described herein enable repeatable and reliable tree modeling to calculate quickly and easily estimates of total canopy cover (TCC), the volumetric canopy crown using in-situ tree measurements, and the formation of unique geometric models. Many embodiments described herein require less computing power than is required for previously known tree modeling methods.

In remote sensing, “ground truth” refers to information collected on location (in-situ). Ground truthing allows image data to be related to real features and materials on the ground. The collection of ground truth data enables calibration of remote-sensing data, and aids in the interpretation and analysis of what is being sensed. Examples include cartography, meteorology, astronomy, astrophotography, analysis of aerial photographs, satellite imagery, and other techniques in which data are gathered at a distance.

Each year new remote sensing and geospatial products and platforms are developed across spectral, temporal, radiometric, and spatial resolutions. Conversely, there are very few new methods for calibrating the accuracy of these products to in-situ collected data. New methodologies and tree models are needed to calibrate sub-meter and sub-foot data sets, which at times are used as ground truth layers because of their high resolution, where high resolution is generally considered 5 meters/pixel for remote sensing. Remote sensing and geographic information systems (GISs) can aid greatly in classifying land types; however, in overly complex environments these technologies cannot replace field data. (See e.g., Estes et al., 2008 Remote Sensing of Environment, 112(5):2033-2050; the disclosure of which is hereby incorporated by reference in its entirety.) The 3D ground truth tree models that do exist are primarily for one type of tree structure and are not easily repeatable. Many embodiments described herein present repeatable geometric models that can be adapted to a variety of tree forms and can be used to calibrate allometric models, since embodiments described herein are not based on allometry but rather on actual three-dimensional tree data.

Light detection and ranging (LiDAR) equipment and/or scanning can be very expensive, thus limiting the ability of entities to obtain measurements or estimates of total canopy cover (TCC) and canopy volume. However, with the advent of global imaging, including Google Maps, Google Earth, and various other free or inexpensive methodologies, which can provide an estimate for canopy. However, these systems provide only a two-dimensional estimate, rather than a three-dimensional measurement of canopy. Many embodiments described herein allow for data harmonization with existing 2D and 3D resolution products and allometric estimates, since an individual tree is modeled by an irregular yet mathematically defined shape using hybrid geometric structures constructed from in-situ tree data measurements. As such, many embodiments are capable of providing volumetric estimates of tree growth, where such metrics are not available or too expensive to obtain. As such, various embodiments provide three-dimensional reconstructions of trees, tree canopies, and tree architectures that can be used to estimate total biomass, leaf area index, carbon storage, and other target metrics that use volume as a proxy. Further embodiments provide two-dimensional reconstructions of trees, tree canopies, and tree architectures that can be used to estimate total canopy cover (TCC) and canopy volume.

### Geometric Modeling of a Tree

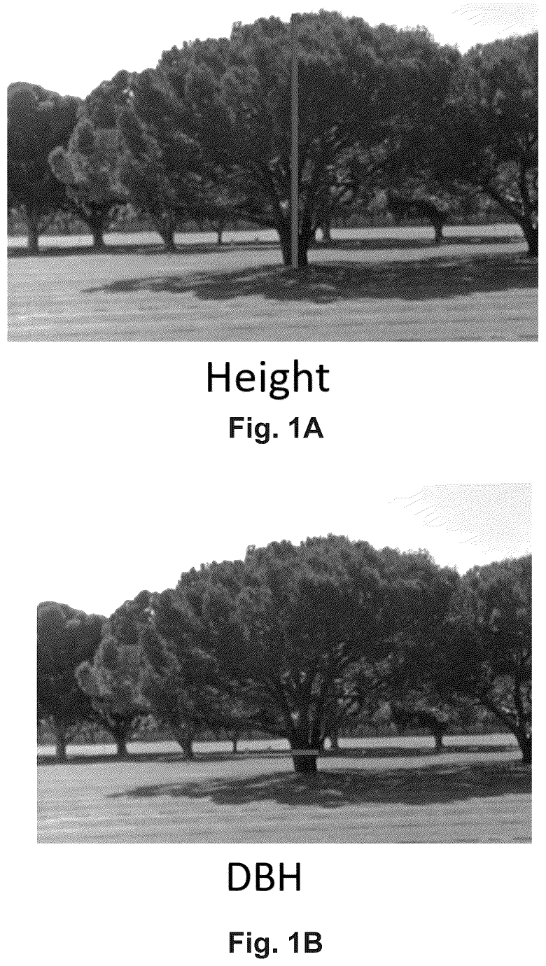

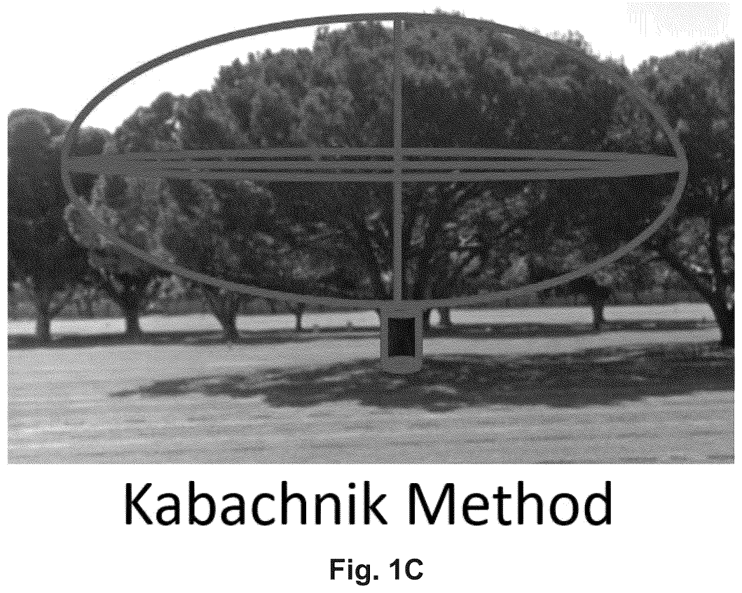

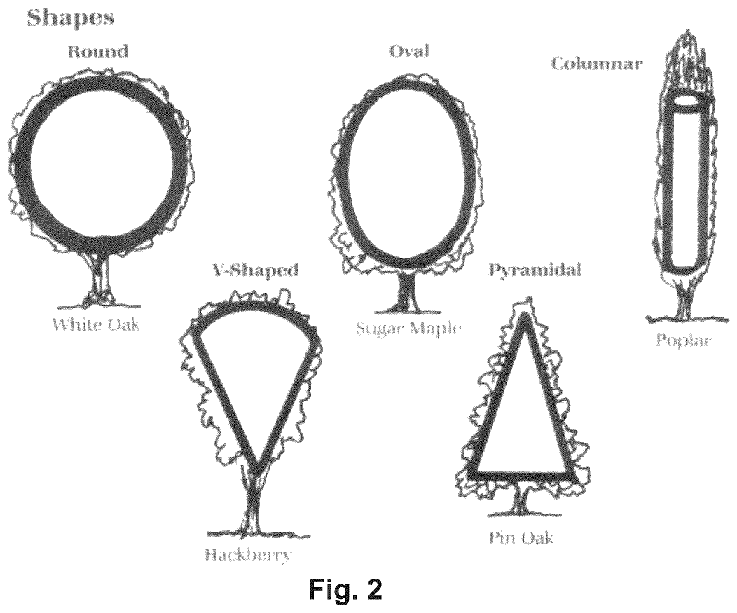

Turning to FIGS. 1A-1B, traditional methods of tree modeling utilize solely allometric models, such as using simple measures such as tree height (FIG. 1A) and diameter at breast height (FIG. 1B). These traditional allometric models are age dependent and species specific, making such modeling difficult to use for large study areas. Additionally, such modeling fails to appreciate the geometric modeling of a tree crown. In contrast, FIG. 1C illustrates a more accurate method, in accordance with many embodiments, which models as a geometric shape to estimate a size and shape of the tree crown, which in this example is roughly spherical with a stem. It should be noted that the geometric shape of trees can be modeled as any number of shapes to approximate the canopy—for example, FIG. 2 illustrates additional shapes that can be modeled, including (but not limited to) round, oval, columnar, V-shaped, and pyramidal as compared to various common tree species. However, additional embodiments can model cylindrical, oblong, hemispherical, and various irregular shapes in line with other tree species. As such, many embodiments utilize in-situ measurements of trees to create a custom, 3D tree model shapes that can be used to model any species at any age.

As will be described below, many embodiments model various shapes using a four quadrant hybrid of ellipsoid shapes to provide an estimate of canopy area of a single tree. Certain embodiments obtain this data from ground verified data, including via a laser range finder and/or DBH tape. Various embodiments collect the ground verified data in four direction planes for each tree using the trunk as a center point. Various embodiments collect non-geometric data as well. Various embodiments collect at least one attribute selected from Table 1.

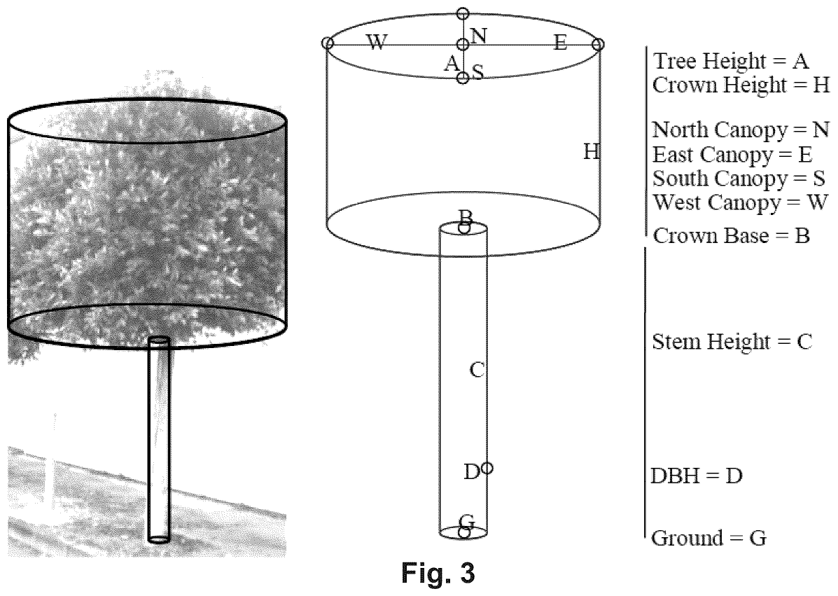

In various embodiments DBH is measured at 1.3 meters above ground, while canopy measurements (e.g., north, east, west, south) are measured by laser pulsing the tree trunk from the canopy extent at the specified direction. Additionally, tree height and crown base can be obtained by triangulating the height based on user location, ground point and either tree height point or crown base point. A schematic of the various geometric attributes is shown in FIG. 3. Specifically, FIG. 3 illustrates the point of measurement fora ground measurement (e.g., elevation of tree), tree height, DBH, crown base, crown height (e.g., distance from crown base to tree height), stem height (e.g., distance from ground to crown base), and compass-directional (e.g., north, south, east, and west) measurements of canopy (e.g., distance from western point to tree trunk, etc.). While FIG. 3 illustrates the four cardinal directions (e.g., north, south, east, and west). Additional embodiments obtain measurements from ordinal (e.g., northeast, southeast, southwest, and northwest) and/or subordinal (or secondary intercardinal) directions (e.g., north northeast, east northeast, etc.). In embodiments that include ordinal and/or subordinal directions, geometric models can include eight or sixteen sections, rather than the four quadrants used in embodiments limited to four directional measurements.

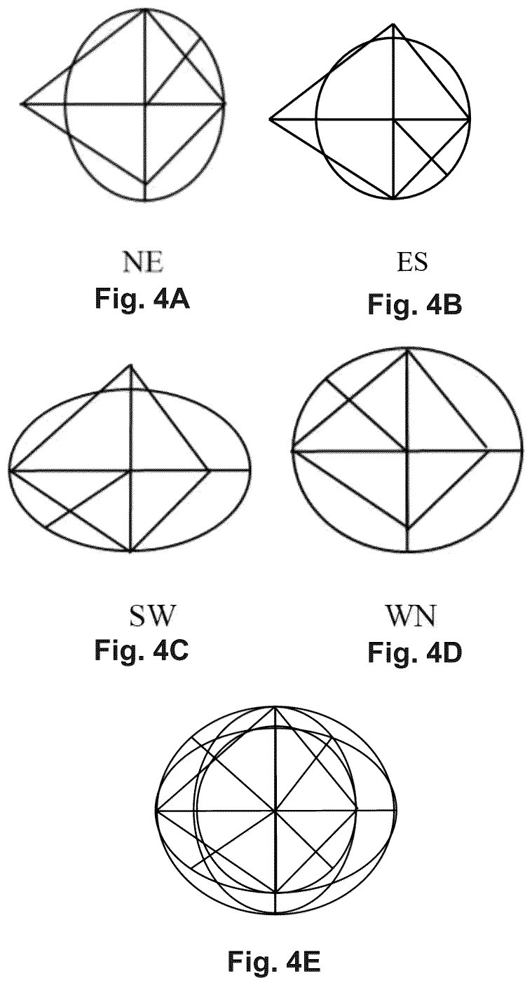

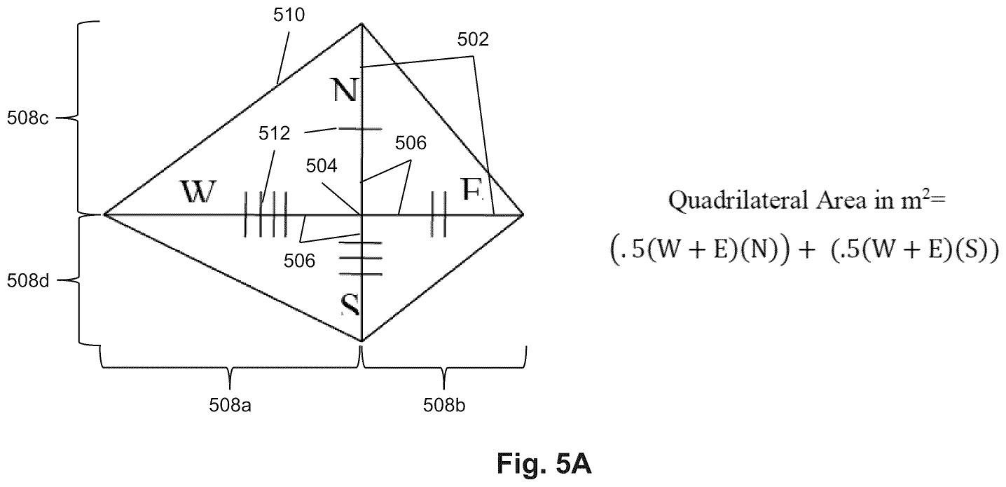

Upon obtaining directional canopy measurements, many embodiments divide the canopy into quadrants representing the area between two measurements, such as a north-east, east-south, south-west, and west-north quadrants—for example, the north-east quadrant is the area between a north canopy distance measurement and east canopy distance measurement. By obtaining cardinal measurements, various embodiments obtain measurements of tree canopy extent at each cardinal direction (e.g., north, south, east, and west) to provide a replicable measurement of total canopy area. Connecting the points provides a quadrilateral representing a low-end estimate of total canopy area, while an ellipse made from the points can provide a high-end estimate of total canopy area. FIGS. 4A-4E illustrate an exemplary 2D canopy modeling of a tree canopy based on elliptical curves customized for each quadrant, where the center point illustrates the tree trunk and the four points are the extent of the canopy at each cardinal direction. In particular, FIGS. 4A-4D illustrate the four quadrants as described above with an overlaid ellipse and quadrilateral that represents the specific quadrant. Specifically, FIG. 4A illustrates the north-east quadrant; FIG. 4B represents the east-south quadrant; FIG. 4C illustrates the south-west quadrant; and FIG. 4D illustrates the west-north quadrant. FIG. 4E illustrates an overlay of all four quadrants and their associated four ellipses into one composite model of how the Kabachnik shapes are created. The Kabachnik shapes can be constructed from 4, 8, 16 or infinite quadrants or wedges depending on 2D or 3D modeling needs. Using this method of creating topologically seamless irregular Kabachnik shapes only requires that the ellipses created from quadrants or wedges of multiple ellipses must share an arm for each side of the quadrant or wedge for the shape to be topologically seamless in 2D or 3D.

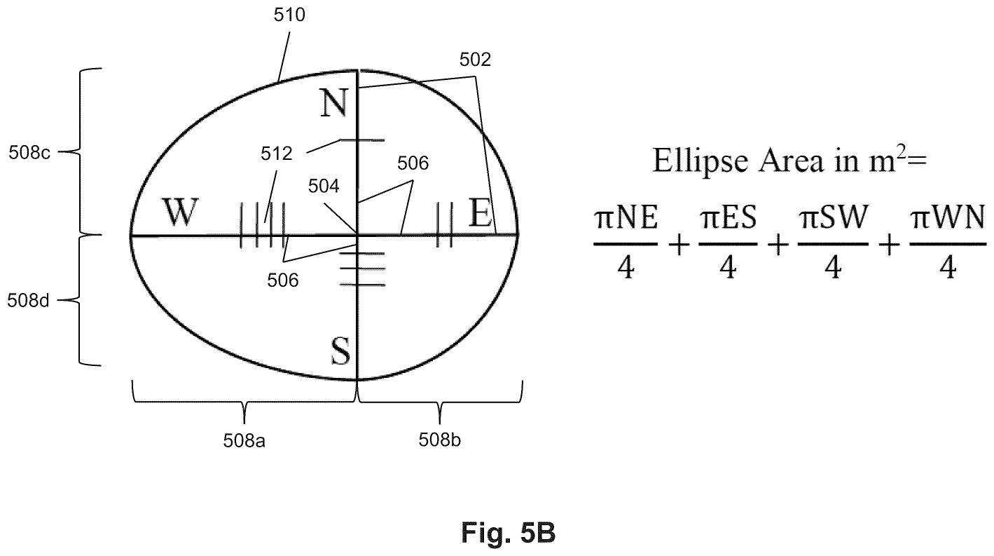

FIGS. 5A-5B illustrate a custom quadrilateral and a custom ellipse, also known as a Kabachnik quadrilateral and a Kabachnik ellipse, respectively, in accordance with various embodiments. Specifically, FIG. 5A shows a Kabachnik quadrilateral formed by the cardinal measurements, providing a low canopy cover estimate, while FIG. 5B illustrates a Kabachnik ellipse formed by the cardinal measurements, providing a high canopy cover estimate. The Kabachnik quadrilateral and Kabachnik ellipse are characterized by two perpendicular and intersecting axes 502. Axes 502 intersect at intersection 504, which roughly indicates the position of a tree stem or tree trunk. Additionally, in many embodiments, each arm 506 extends from intersection 504 to the directional canopy distance (e.g., north canopy distance, east canopy distance, etc.) as indicated by N, E, S, and W (also illustrated in FIG. 3). In various embodiments, each arm 506 possesses a length 508a, 508b, 508c, 508d. In some embodiments, lengths 508a, 508b, 508c, 508d are all unique lengths (e.g., 508a≠508b≠508c≠508d), while in some embodiments, one or more lengths are the same (e.g., 508a=508b≠508c≠508d), such as illustrated by hatches 512. Many embodiments possess a perimeter 510 connecting each directional canopy distance, thus forming a continuous and closed shape as an estimate of canopy. Equations for calculating the area of the quadrilateral (FIG. 5A and ellipse (FIG. 5B) are represented in their respective figures, where the letters in the equations represent the measurements illustrated in FIG. 3. Many embodiments improve the 2D modeling by producing the Kabachnik shapes, such as illustrated in FIGS. 5A-5B.

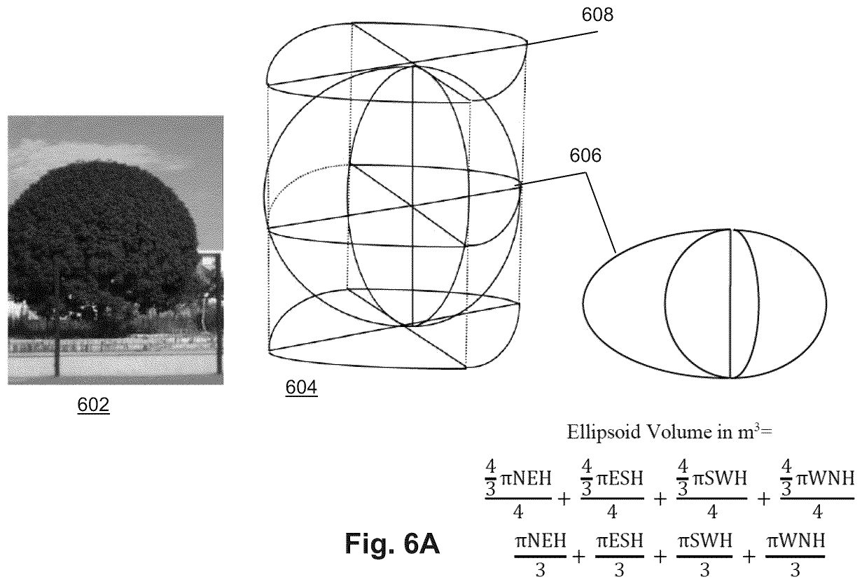

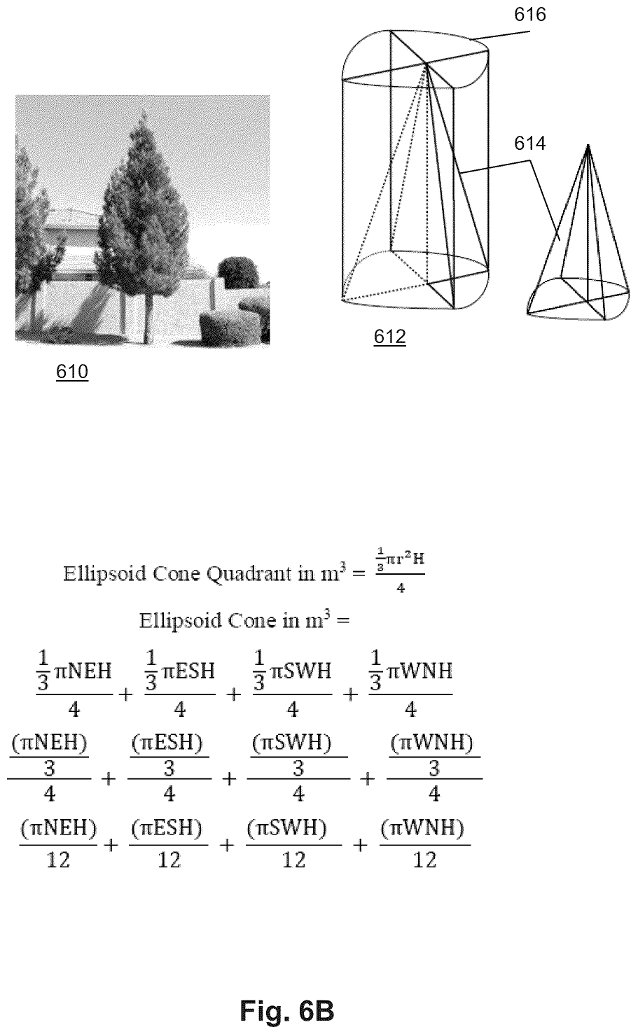

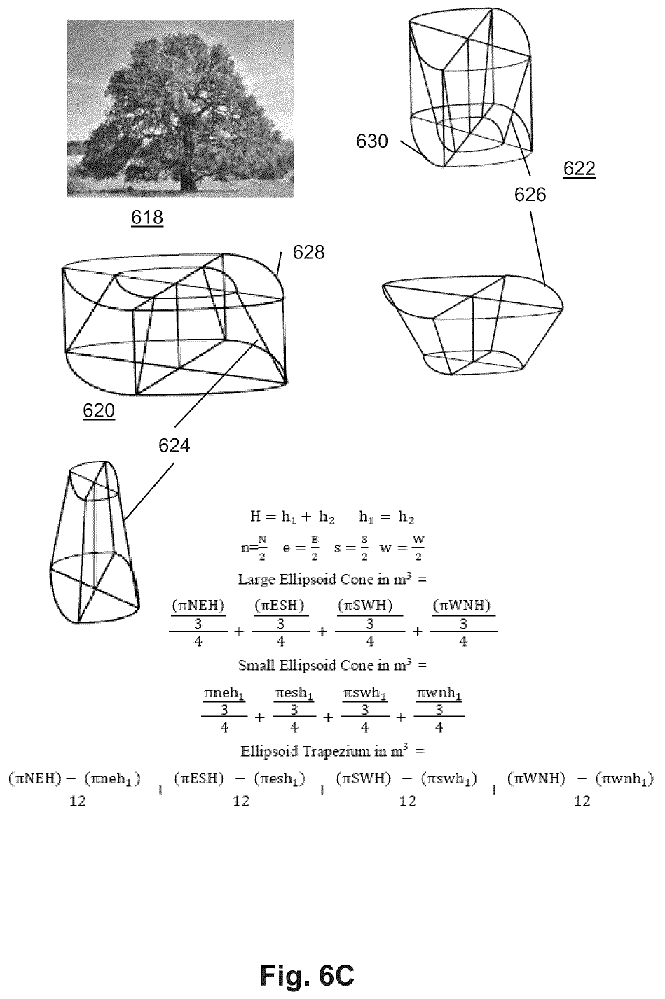

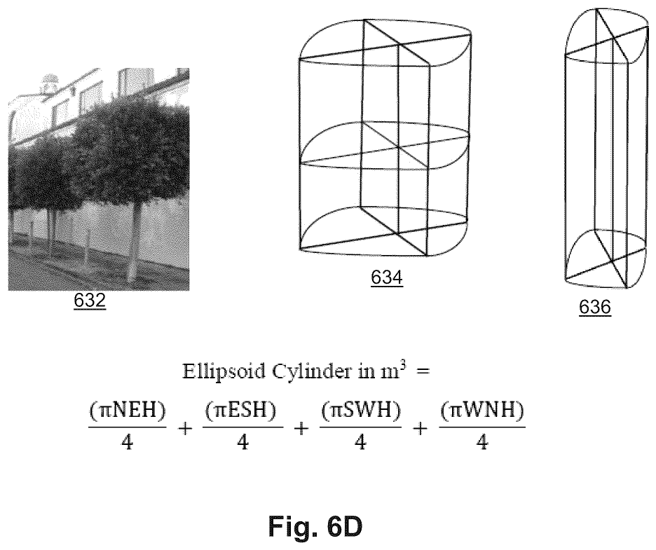

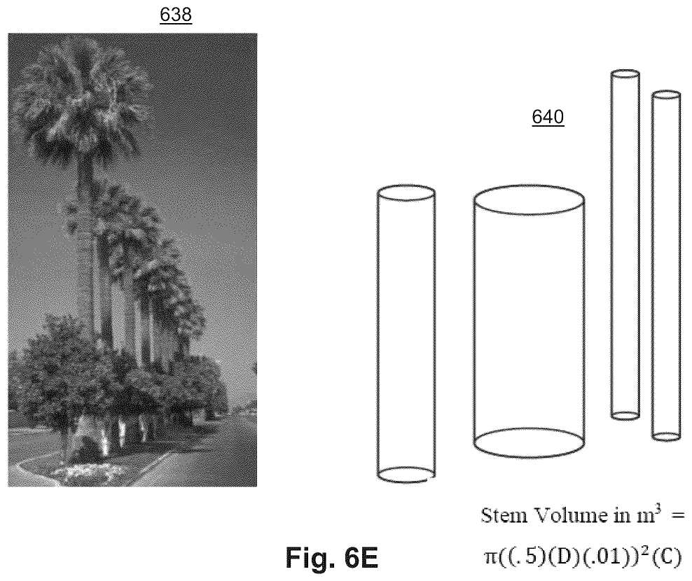

Quadrant measurements can also be used to generate 3D models for tree crown geometry. Such volumetric measurements can provide estimates of crown volume, which are used as a proxy for biomass, carbon, and other ecosystem services. FIGS. 6A-6D illustrate examples of custom shapes, including (but not limited to) Kabachnik ellipsoids (FIG. 6A), Kabachnik ellipsoid cones (FIGS. 6B-6C), Kabachnik ellipsoid trapeziums (FIG. 6C), and Kabachnik ellipsoid cylinders (FIG. 6D) to model tree crown geometry along with their respective equations for calculating volume. For example, FIG. 6A illustrates a tree 602 with a Kabachnik ellipsoid shaped crown. A columnar view 604 of the Kabachnik ellipsoid is shown, which demonstrates both a 3D model 606 of the tree crown and a 2D representation of the Kabachnik ellipse 608. Similarly, FIG. 6B illustrates a tree 610 possessing a Kabachnik ellipsoid cone shaped crown. Columnar view 612 illustrates the 3D representation 614 of the Kabachnik ellipsoid cone along with a 2D representation of the Kabachnik ellipse 616. Additionally, FIG. 6C illustrates another version of Kabachnik ellipsoid cone possessing a flattened top (rather than a point illustrated in FIG. 6B). An inverted version of this Kabachnik ellipsoid cone is the Kabachnik ellipsoid trapezium, which is roughly an inverted version of this Kabachnik ellipsoid cone. Columnar views 620, 622 illustrate the Kabachnik ellipsoid cone and Kabachnik ellipsoid trapezium respectively, showing 3D representations of the Kabachnik ellipsoid cone 624 and Kabachnik ellipsoid trapezium 626, respectively. Additionally, columnar view 620, 622 each illustrate respective Kabachnik ellipses 628, 630 as a 2D representation. Finally, FIG. 6D illustrates a tree 632 possessing a Kabachnik ellipsoid cylinder shaped crown. Columnar views 634, 636 show different perspective views of the 3D representation of the Kabachnik ellipsoid cylinder. As a generally cylindrical shape, the 2D representation of the Kabachnik ellipse is the same as the base and apex of the Kabachnik ellipsoid cylinder. Related FIG. 6E illustrates modeling of a stem or trunk of a tree or for trees with multiple trunks, which are often not surveyed. As an example, palm trees 638 demonstrate the necessity for a stem model, such as demonstrated by cylinders 640.

The parameters obtained via ground truth observations comprise ground truth data that allows embodiments to model a tree into custom, Kabachnik shapes, based on basic geometric shapes (e.g., quadrilateral, triangle, cone, cylinder, and ellipsoid)to model a tree into 2D and 3D forms. Such methodologies can be applied to photogrammetric data (e.g., parallax images such that the images are obtained from different angles and used to extract 3D measurements). Such data can be acquired or obtained from aerial (e.g., manned aircraft, remote controlled, drone, etc.) or space-based sensors (e.g., satellite, space station, etc.), where images can be obtained from different angles based on specific position of the camera, such as orbital position of a satellite or space station, or for space phenomena (e.g., nebulae, etc.) from an earth-based sensor (e.g., telescope, camera, etc.).

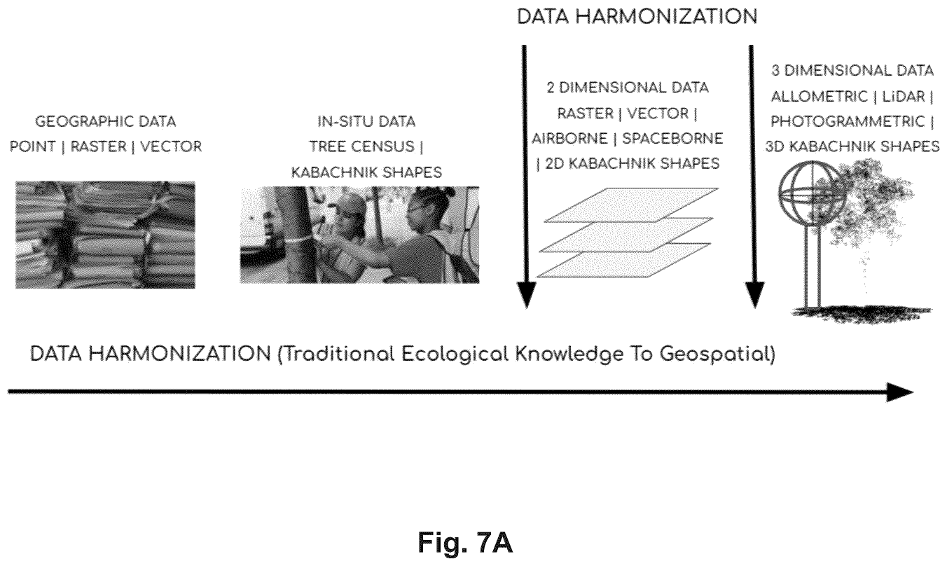

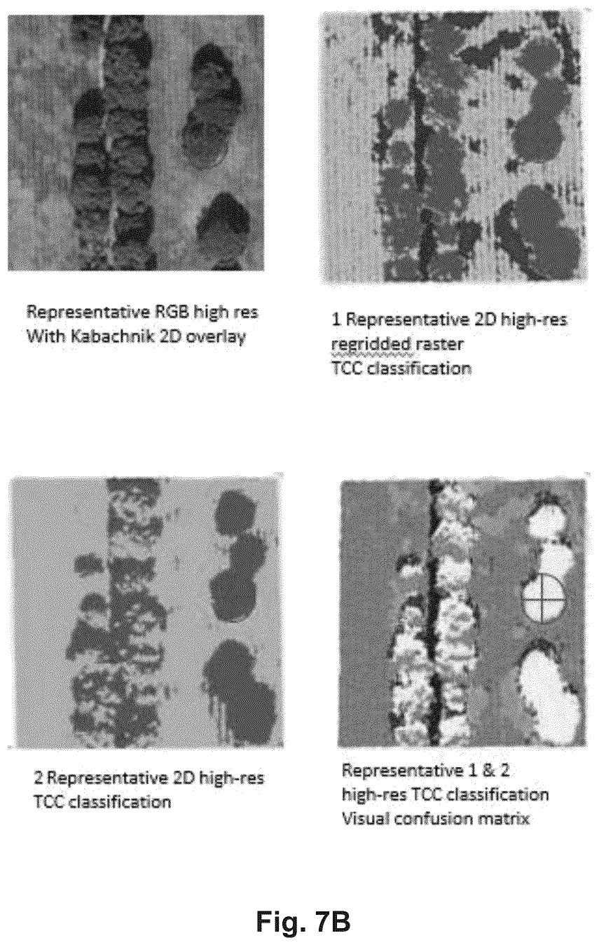

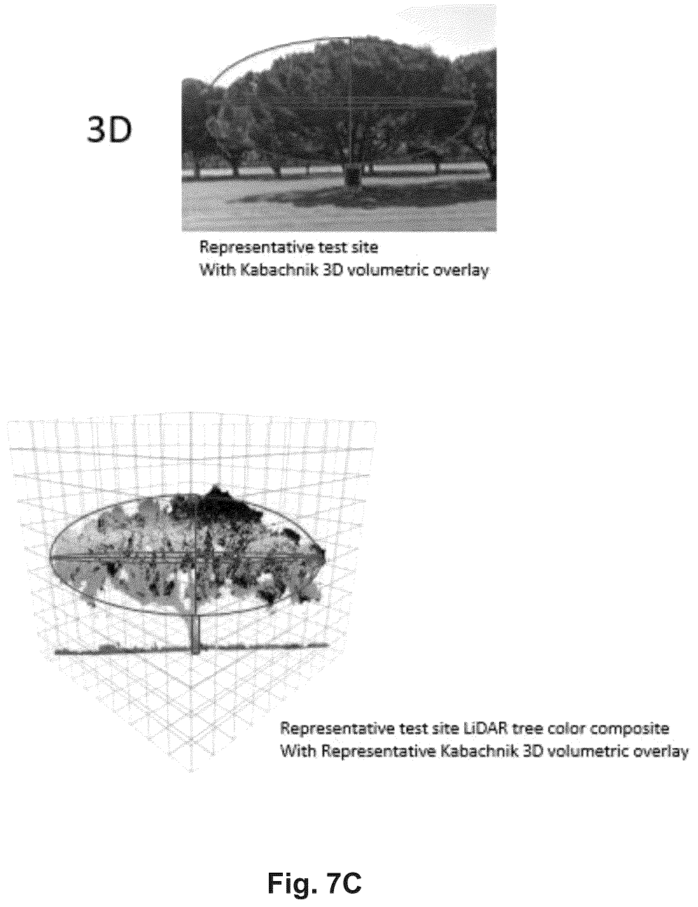

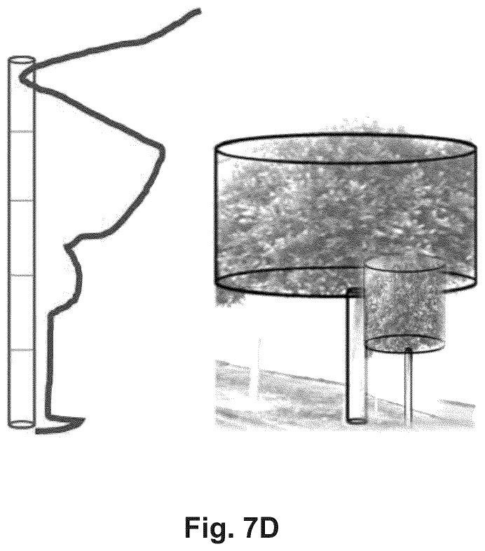

As described herein, by obtaining in-situ geometric parameters of a tree, many embodiments produce 2D and 3D ground verification datasets that can be used to test the accuracy of parameters estimated from 2D imaging and 3D imaging, such as LiDAR and photogrammetry. Two-dimensional imaging can allow for determination of total canopy cover of an area via pixel processing, such that individual pixels within an image are classified as specific phenomena (e.g., trees, pavement, etc.). FIG. 7A illustrates a flow of data harmonization in accordance with various embodiments, where geographic data is harmonized with in-situ data (e.g., observations and/or measurements) to model 2D data and/or 3D data for improved spatial analysis.

Turning to FIG. 7B, due to the glut of sub-foot and sub-meter data from high resolution satellites, drones, and UAVs, certain embodiments begin with pixel size harmonization through pixel size reassignment and then by using a 2D Kabachnik shape, derived from in-situ observations, to provide an in-situ derived mathematical and georectified spatial estimation of the geolocated shape measurements of the tree. The 2D Kabachnik shape overlaid on to 2D imagery can then “clip” 2D tree classified pixels to exclude classification errors while also providing an estimate of TCC entirely from in-situ measurements that are not image dependent. FIG. 7C illustrates how certain embodiments use the 2D pixel size to harmonize 2D data with 3D data by reclassifying voxels to the same size as the 2D imagery pixel size and then create a 3D canopy crown “clip” to harmonize 3D data in a voxel grid overlaid with a Kabachnik shape. This enables for contiguous harmonization across each data type:
From in-situ data and observations to 2D data and 3D data;
All in-situ data models;
All 2D data models; and
All 3D models.

Once the data is harmonized and geographically fit, robust geospatial statistical analysis becomes possible in both 2D and 3D. In general, data harmonization seeks to bring together various types, levels, and sources of data, which represent measurement of the same latent construct(s), in such a way that they can be made compatible and comparable. Harmonization in accordance with various embodiments, can include, for example, one or more of regridding, rasterization, fishnetting, and interpolating.
Regridding is the process of interpolating from one grid resolution to a different grid resolution. This could involve temporal, vertical or spatial (‘horizontal’) interpolations. However, most commonly, regridding refers to spatial interpolation.
Rasterization is the task of taking an image described in a vector graphics format (shapes) and converting it into a raster image (a series of pixels, dots or lines, which, when displayed together, create the image which was represented via shapes).
Fishnetting is a process to generate a series of rectangular cells, such as pixels and/or voxels. The fishnet can have polyline or polygon features.
Interpolating is the process of using points with known values to estimate values at other points. Spatial interpolation is typically applied to a raster with estimates made for all cells. Spatial interpolation is therefore a means of creating surface data from sample points.

Three-dimensional imaging allows for characterization of volume as a proxy for biomass. FIG. 7D illustrates an example of how various embodiments reconcile LiDAR data with tree modeling. In typical LiDAR data collection, data is obtained as a point cloud, which does not reveal underlying tree geometry. As illustrated in FIG. 7D, LiDAR returns for specific positions can be reconciled with tree geometries to identify tree shape, which can reveal canopy volume and/or biomass for an area or region of interest. To accomplish this, certain embodiments identify LiDAR cloud point density points that exist within the canopy based on in-situ datasets, such as those described herein, and points that exist external to the actual tree canopy. Such methods can be used to estimate tree canopy density and in general calibrate canopy data and models derived from LiDAR and photogrammetric 3D data collection methods. Using the Kabachnik shapes of the trees modeled, 3D data of any kind can be clipped, fitted, processed, and geospatially statistically analyzed, harmonized, and ground-truthed based on in-situ data which are the central use of the embodiments of the Kabachnik shape model.

Such modeling improves the accuracy over current canopy cover analysis methods by breaking a canopy into multiple and repeatable sections (e.g., four quadrants) that model and quantify the uneven nature of a lopsided canopy form and/or other irregular shapes caused by environmental or other factors (e.g., pruning, power lines, buildings, other trees, signs, vehicle shearing, aesthetics, habitat, and other urban factors). This modeling can be used for various uses, including tree management (e.g., in parks, urban areas, forests, etc.), generating tree census data, creating volumetric data for biomass, and identifying total canopy cover.

While the above section describes methodologies to ground truth trees and canopy cover, several embodiments described herein are fully applicable to other features or phenomena on Earth, and other planets, and to inventory space phenomena having Kabachnik-like shapes in 2D and/or 3D, such as to measure vapor plumes, volcanic eruptions, cloud cover, sea cover, etc. on Earth, Mars, or other planetary body. Remotely sensed phenomena from satellites looking out to space, or from embedded sensors like earth telescopes, astrophotography, and other astronomical sensors may be similarly calibrated using embodiments described herein. Highly irregular shapes, such as space phenomena in 2D and 3D, are more accurately modeled using hybrid custom geometries, such as Kabachnik shapes, and the present methods may be used to calibrate space photogrammetry and space images processed via spectral, temporal, radiometric, and spatial resolutions in 2D and 3D via a pixel net and/or voxel grid with the Kabachnik shape overlaid in Cartesian space. Such embodiments provide repeatable methods that can also be used for change detection in any inventoried phenomena.

### Remote Sensing

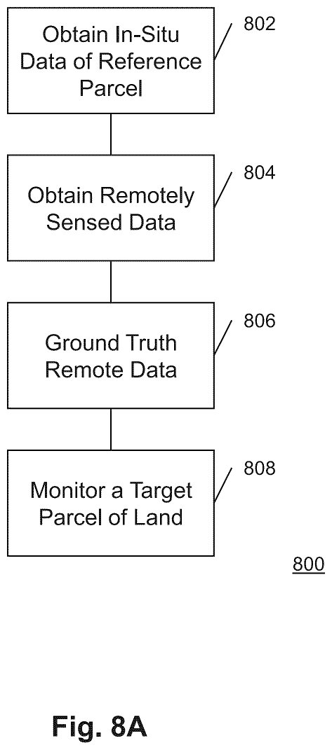

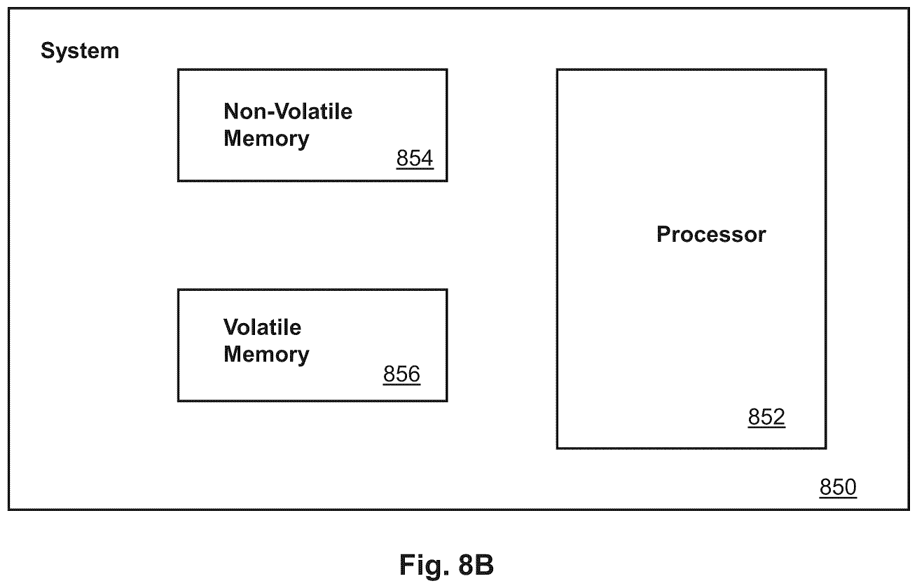

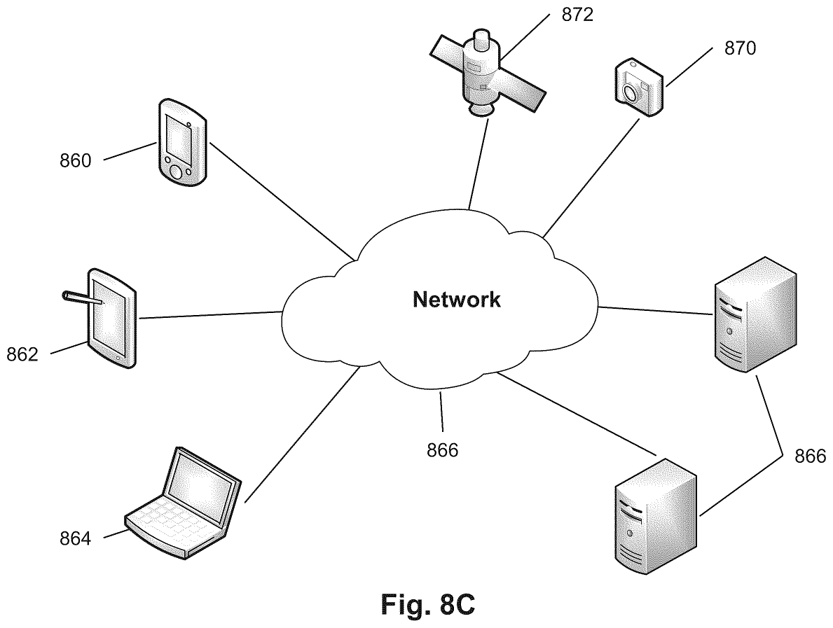

Turning to FIG. 8A, many embodiments are directed to improve remote sensing methodologies, including to determine total canopy cover, such as method 800. In many embodiments, remote sensing obtains ground truth in-situ data for a reference parcel of land at 802. In many embodiments, the reference parcel contains at least one tree. In some embodiments, obtaining ground truth in-situ data involves generating in-situ measurements of the at least one tree comprised in the reference parcel of land, such as described herein. In various embodiments, the generating ground truth in-situ data involves measuring the at least one tree in the reference parcel location, such as described elsewhere herein. In certain embodiments, the reference parcel of land is a demarcated plot of land, a park, a cemetery, a street median, or any other parcel of land. Some embodiments collect tree species information for specific trees within the area used as in-situ, ground truth data.

At 804, various embodiments obtain a remotely sensed dataset of a parcel of land. In many of these embodiments, the parcel of land is the reference parcel of land as identified in 802. In some embodiments, the remotely sensed dataset is obtained via cameras and/or sensors on airborne crafts (e.g., airplanes, rotorcraft, lighter-than-air craft, drones, unmanned aerial vehicles or systems (UAVs or UASs), etc.) or satellites. In certain embodiments, the remotely sensed dataset is obtained via LiDAR, photogrammetry, multi-spectral bands, and/or at various spatial resolutions. In certain embodiments the remotely sensed dataset is obtained at approximately the same time as in-situ data (e.g., within the same day, season, or year), while some embodiments obtain remote sensing data at a different time from the in-situ data, such as a different time of day, different month, different season, or other temporal unit.

Many embodiments ground truth the remote sensing data at 806. In certain embodiments, the data from the remotely sensed data is calibrated to the ground truth in-situ data (e.g., obtained at 802). In some embodiments, the correlation comprises correlating the remotely sensed to 2D and/or 3D geometries identified in the ground truth in-situ data for the at least one tree in the reference parcel. Ground truthing can include processing pixels, voxels, spectrometry, or other unit obtained via the remotely sensed data with the in-situ data. As noted above, many embodiments assess pixels to generate a 2D construct of the parcel, which can identify tree canopy coverage (TCC). Additionally, various sensing methods (e.g., LiDAR, photogrammetry) generate a 3D construct of at least one tree in the area, such as described herein. As noted above, the 3D constructs can be used to determine biomass, leaf area index, carbon storage, and/or other target metrics that use volume as a proxy.

Further embodiments monitor a target parcel of land via remote sensing at 808. In many embodiments, monitoring a target parcel of land uses a remotely sensed dataset. In certain embodiments, monitoring a target parcel can monitor the target parcel for any changes or alterations, including gain and/or loss in trees, brush, other plant growth, other natural and manmade landscape features, and/or combinations thereof. Such monitoring can include obtaining additional remotely sensed data and ground truthing the additional data. In various embodiments, this additional data is taken at a different time than the first dataset (e.g., 1 hour, 6 hours, 12 hours, 1 day, 1 week, 1 month, 3 months, 6 months, 12 months, etc.) to determine any spatial, radiometric, spectral, and/or temporal changes in the area between the data obtention. In monitoring a target parcel, numerous embodiments harmonize obtained data in 2D, 3D, using such methods as those described herein.

In certain embodiments, the target parcel contains the same parcel from which ground truth in-situ data was obtained (e.g., reference parcel from 802). In some embodiments, the target parcel does not include the reference parcel of land (e.g., the target parcel is different than the reference parcel of land). In other embodiments, the target parcel contains both the reference parcel and an additional area that was not ground truthed. In some of these embodiments, the additional area is contiguous with the reference parcel, while some embodiments, the additional area is not contiguous with the reference parcel.

It should be noted that the features discussed in relation to method 800 can be completed in a differing order, repeated, and/or omitted in accordance with various embodiments, such as repeating obtaining in-situ data and ground truthing the remotely sensed dataset. Additionally, some embodiments may omit monitoring the parcel.

Furthermore, while method 800 is described in the context of remote sensing of trees on planet Earth, one of skill in the art would understand the ability to apply the same method on other planetary bodies and for other targets, such as vapor plumes, volcanic eruptions, and other phenomena.

Turning to FIG. 8B, one skilled in the art will recognize that systems and methods in accordance with various embodiments may include computer systems, such as local, networked, remote, and/or any other computerized system. As such, certain embodiments are directed to systems 850 including a processor 852, a non-volatile memory 854, and a volatile memory 856. The processor 852 is a processor, microprocessor, controller, or a combination of processors, microprocessor, and/or controllers that perform instructions stored in the volatile memory 856 or non-volatile memory 854 to manipulate data stored in the memory. The non-volatile memory 854 can store the processor instructions utilized to configure the system 850 to perform processes including method 800. In accordance with various other embodiments, system 850 may have hardware and/or firmware that can include the instructions and/or perform these processes. In accordance with still other embodiments, the instructions for the processes can be stored in any of a variety of non-transitory computer readable media appropriate to a specific application.

Turning to FIG. 8C, a network diagram used in accordance with some embodiments is illustrated. In such embodiments, input devices, such as tablets 860, mobile phones 862, personal computers 864, and other data gathering devices are used to obtain data, such as in-situ data. Such data can be stored locally on the input devices, while certain embodiments send such data to a remote computing device, such as one or more servers 866 via one or more networks 868 (e.g., internet, LAN, etc.). Further embodiments obtain monitoring data from sensors, such as camera 870, satellite 872, and/or any other imaging device. Imagery can be stored on input devices or computing servers, such as transmitted via a network. Data harmonization and/or other types of analysis can be processed on input devices or a computing server, depending on computing power, storage space, and/or any other factor driving selection for convenience and/or efficiency.

### EXEMPLARY EMBODIMENTS

Although the following embodiments provide details on certain embodiments of the inventions, it should be understood that these are only exemplary in nature, and are not intended to limit the scope of the invention.

### Example 1: Remote Sensing and GIS

METHODS: Two high resolution data products were used in this study. The first was an HDF product based on a Quickbird Total Canopy Cover (TCC) supervised classification created and provided by McPherson from the USDA Pacific Southwest Research Station. The second was a Google Earth product (e.g., a screen capture). (See e.g., McPherson, E. G. (2008). Los Angeles 1-Million tree canopy cover assessment. United States Department of Agriculture Forest Service, Pacific Southwest Research Station. PSW-GTR-207; the disclosure of which is hereby incorporated by reference in its entirety.)

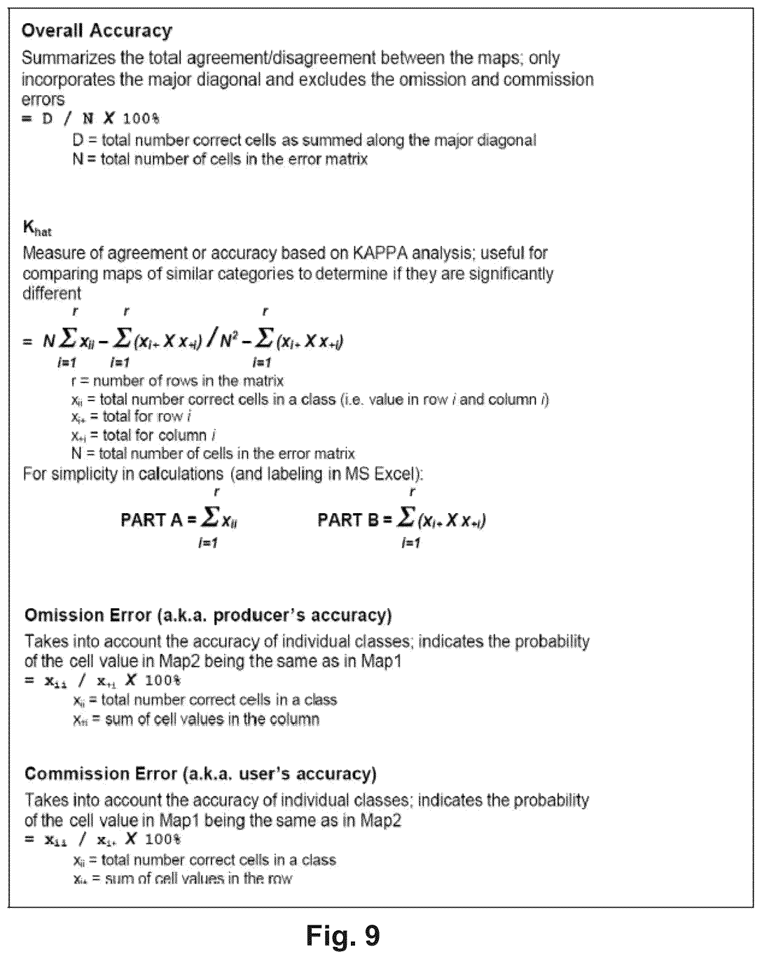

The Google Earth product can be processed so that an error matrix analysis can be used to assess the accuracy of identifying Total Canopy Cover and other USDAFS classifications. The categories were modeled after the McPherson classes used in the USDAFS product. (See e.g., McPherson, E. G., cited above.) An error matrix (see FIG. 9) was created from each product by site to test the accuracy of the Google Earth product classification against the McPherson Quickbird HDF product classification. The error matrix methodology used was developed specifically for change detection in classification schemes (Jensen, 2005). The TCC estimates for both products were then ground verified using ground truthing methodologies described herein.

RESULTS: At a first site, the low estimate for tree canopy cover derived from a quadrilateral was 4323.9 m² and the high estimate derived from the Ellipse was 7307.5 m². Google estimated canopy cover was 6345 m², and the McPherson product estimate was 8273 m². The error matrix identified that the overlay of Google and McPherson TCC estimate was 4842 m². For the first site, the high estimate for the Ellipse underestimated the McPherson TCC by 966 m², and overestimated the Google TCC by 962 m². The error matrix of both products TCC estimate fell between the embodiment's low and high estimate.

The Google classification and the McPherson classification gave different estimates for TCC because of two main reasons: multi-story canopy and shadow classification error. There were high shadow and impervious surface classification errors in the McPherson data set. The Google classification also had some shadow error, but far less than the McPherson. The McPherson classification was created for the entire City of Los Angeles using a few dozen in-situ verification sites. The Google Earth classification which was done manually for a significantly smaller study area was the most accurate classification of TCC because of the difference in scale of the study area and the attention to the classification of a smaller study area. The McPherson TCC estimate of canopy cover had an over estimation error of approximately 1,928 m². The Google Earth product had lower TCC than the embodiment, because in-situ data calculates each tree canopy and the image cannot because of the overlap of multistory canopy when viewed and quantified from above, hence giving a greater TCC. Some image classification errors are due to the images being captured at different times in the same season on different years, though both were taken near seasonal canopy peak. You can see these errors and examples of inter-annual variance, shadow, complex canopy, and multi-story canopy in the following maps.

For a second site, the low estimate for canopy cover derived from the quadrilateral was 3,535 m² and the high estimate derived from the Ellipse was 6,140 m². Canopy cover estimated from Google Earth imagery was 3,468 m², and the McPherson product estimate was 3484 m². The second site sheds more insight into the potential accuracy of the Ellipse shapes since there is zero multistory canopy area. The canopy area closely matched the embodiment's low canopy estimate. The high estimate for the Ellipse over estimated canopy cover by 2,672 m² for the Google classification and 2,656 m² for the McPherson classification. The McPherson Canopy Cover prediction was only 16 m² greater than the Google classification. When there is no crown competition like at the second site, open grown trees will grow faster than trees in closed canopies. (See e.g., Nowak, D. J., (2015). The Science and Future of i-Tree. USDAFS Urban Forest Connections. Retrieved June 2019. www.fs.fed.us/research/docs/webinars/urban-forests/i-tree/transcript.pdf; the disclosure of which is hereby incorporated by reference in its entirety.) Some of the variation in estimates could be from the growth of the canopy from when the images were taken versus when the ground survey occurred a few years later.

The four classes used for this study were created by McPherson (2008): Tree (tree and shrub), Grass, (green grass and ground cover), Dry Grass/Bare Soil (dry grass and bare soil), and Impervious Surface (includes impervious pavement). It is first necessary to provide the classification accuracy of the USDA Forest Service product according to McPherson since this dataset is foundational to the analysis in this paper.

The overall classification accuracy for the Tree class for the McPherson Quickbird product was 76.3% (Table 2) for the first site and 64.3% for the second site (Table 3). At both sites, the highest classification error occurred with tree canopy being mistaken for Irrigated Grass, 19% for Site 1, and 35% for Site 2 tree. Conversely, Irrigated grass was misclassified as Tree, 37% in Site 1 and 12% in Site 2. However, in Site 1, there was an 81% misclassification of dry grass and other as Tree, and about 42% of Impervious surface was misclassified as tree.

For the Tree class, Site 1 had a Producer's Accuracy and Omission Error of 41% and a User's Accuracy and Commission Error of 24%. It had a Khat of 26% and an Overall Accuracy of 55% which is a measure of agreement between the two classifications. McPherson mostly misclassified Irrigated Grass and Dry Grass as tree canopy. The Google product mostly misclassified trees as irrigated grass. For the tree class, Site 2 had a Producer's Accuracy and Omission Error of 36% and a User's Accuracy and Commission error of 36%. It had a Khat of 34% and an Overall Accuracy of 62%. McPherson mostly misclassified Irrigated Grass and Impervious surface as trees. The Google product mostly misclassified trees as irrigated grass.

### DOCTRINE OF EQUIVALENTS

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

TABLE 1
Attributes measured in accordance with various embodiments
Sixteen Tree Attributes Measured

| | | | |
|---|---|---|---|
| Lat/Long* | Family | Tree height*\hat{ } | North Canopy*\hat{ } |
| # Stems* | Genus species* | Crown base*\hat{ } | East Canopy*\hat{ } |
| Native | Invasive | DBH*\hat{ } | South Canopy*\hat{ } |
| Deciduous | Evergreen | Ground*\hat{ } | West Canopy*\hat{ } |

*Parameter taken in the field,
\hat{ }Geometric measurement

TABLE 2
Site 1 canopy accuracy by imagery product

| | USDAFS, McPherson, 2008 | | | | | |
|---|---|---|---|---|---|---|
| | | | | Irrigated | Dry | Google |
| | PIXEL | Impervious | Tree | Grass | Grass/Other | Total |
| Google | Impervious | 851 | 1788 | 1587 | 82 | 4308 |
| | Tree | 686 | 13450 | 3356 | 135 | 17627 |
| | Irrigated Grass | 148 | 3409 | 5528 | 96 | 9181 |
| | Dry | 600 | 4336 | 382 | 70 | 5388 |
| | Grass/Other | | | | | |
| | USDAFS Total | 2285 | 22983 | 10853 | 383 | 36504 |

| | USDAFS, McPherson, 2008 | | | | |
|---|---|---|---|---|---|
| | PERCENT | Impervious | Tree | Irrigated | Dry |
| | | | | Grass | Grass/Other |
| Google | Impervious | 19.8% | 41.5% | 36.8% | 1.9% |
| | Tree | 3.9% | 76.3% | 19.0% | 0.8% |
| | Irrigated Grass | 1.6% | 37.1% | 60.2% | 1.0% |
| | Dry Grass/Other | 11.1% | 80.5% | 7.19% | 1.3% |

| USDAFS Producer's Accuracy | | | Omission Error |
|---|---|---|---|
| Impervious | 851/2285 | 37% | 63% |
| Tree | 13450/22983 | 59% | 41% |
| Irrigated Grass | 5528/10853 | 51% | 49% |
| Dry Grass/Other | 70/383 | 18% | 82% |
| | | | Commission |
| Google User's Accuracy | | | Error |
| Impervious | 851/4308 | 20% | 80% |
| Tree | 13450/17627 | 76% | 24% |
| Irrigated Grass | 5528/9181 | 60% | 40% |
| Dry Grass/Other | 70/5388 | 1% | 99% |

Two-Dimensional Comparison
McPherson Canopy Area Total: 22983 × .6 m × .6 m = 8273 m²
Google Canopy Area Total: 17627 × 6 m × .6 m = 6345 m²
McPherson/Google Canopy Area (both classified canopy): 13450 × .6 m × 6 m = 4842 m²
ATCM Canopy Area Low: 4323.9 m²
ATCM Canopy Area High: 7307.5 m²
Khat 26%
Overall Accuracy 55%

TABLE 3
Site 2 canopy accuracy by imagery product

| | USDAFS, McPherson, 2008 | | | | | |
|---|---|---|---|---|---|---|
| | | | | Irrigated | Dry | Google |
| | PIXEL | Impervious | Tree | Grass | Grass/Other | Total |
| Google | Impervious | 13 | 1114 | 961 | 8 | 2096 |
| | Tree | 42 | 6190 | 3372 | 30 | 9634 |
| | Irrigated Grass | 19 | 1626 | 11863 | 43 | 13551 |
| | Dray | 9 | 750 | 3317 | 32 | 4108 |
| | Grass/Other | | | | | |
| | USDAFS Total | 83 | 9680 | 19513 | 113 | 29389 |

| | USDAFS, McPherson, 2008 | | | | |
|---|---|---|---|---|---|
| | | | | Irrigated | Dry |
| | PERCENT | Impervious | Tree | Grass | Grass/Other |
| Google | Impervious | 0.6% | 53.1% | 45.8% | 0.4% |
| | Tree | 0.4% | 64.3% | 35.0% | 0.3% |
| | Irrigated | 0.1% | 12.0% | 87.5% | 0.3% |
| | Grass | | | | |
| | Dry | 0.2% | 18.3% | 80.7% | 0.8% |
| | Grass/Other | | | | |

| USDAFS Producer's Accuracy | | | Omission Error |
|---|---|---|---|
| Impervious | 13/83 | 16% | 84% |
| Tree | 6190/9680 | 64% | 36% |
| Irrigated Grass | 11863/19513 | 61% | 39% |
| Dry Grass/Other | 32/113 | 28% | 72% |
| Google User's Accuracy | | | Commission Error |
| Impervious | 13/2096 | 1% | 99% |
| Tree | 6190/9634 | 64% | 36% |
| Irrigated Grass | 11863/13551 | 88% | 12% |
| Dry Grass/Other | 32/4108 | 1% | 99% |

Two Dimensional Comparisons
McPherson Canopy Area Total: 9680 × 6 m × .6 m = 3484 m²
Google Canopy Area Total: 9634 × 6 m × .6 m = 3468 m²
McPherson/Google Canopy Area (both classified canopy): 6190 × 6 m × .6 m = 2228 m²
ATCM Canopy Area Low: 3535 m²
ATCM Canopy Area High: 6140 m²
Khat 34%
Overall Accuracy 62%

1. A method, comprising:
obtaining ground truth data for a reference parcel of land containing at least one tree, wherein the ground truth data includes geometric data for the at least one tree, wherein the geometric data characterizes the at least one tree by a custom shape; and
ground truthing a remotely sensed dataset of the reference parcel of land by correlating the remotely sensed dataset with the ground truth data.

2. The method of claim 1, further comprising generating the geometric data for the at least one tree by measuring at least one geometric attribute of the at least one tree.

3. The method of claim 2, wherein the at least one geometric attribute is selected from the group consisting of: tree height, crown base, diameter at breast height, ground, north canopy, east canopy, south canopy, and west canopy.

4. The method of claim 2, wherein the custom shape is a two-dimensional shape.

5. The method of claim 4, wherein the two-dimensional shape is selected from the group consisting of a Kabachnik ellipse and a Kabachnik quadrilateral, wherein the Kabachnik ellipse is characterized by two perpendicular and intersecting axes, wherein each axis comprises two arms each extending from the intersection, wherein at least one arm has a different length than the other arms, and wherein the Kabachnik quadrilateral is characterized by two perpendicular and intersecting axes, wherein each axis comprises two arms each extending from the intersection, wherein at least one arm has a different length than the other arms.

6. The method of claim 2, wherein the custom shape is a three-dimensional shape.

7. The method of claim 6, wherein the three-dimensional shape is selected from the group consisting of: a Kabachnik ellipsoid, a Kabachnik ellipsoid cone, a Kabachnik ellipsoid trapezium, and a Kabachnik ellipsoid cylinder.

8. The method of claim 1 further comprising obtaining the remotely sensed dataset.

9. The method of claim 8, wherein the remotely sensed dataset comprises satellite imagery, airborne sensor data, airborne photography, photogrammetry, astrophotography, or LiDAR.

10. The method of claim 8, wherein the remotely sensed dataset is a commercial product.

11. The method of claim 10, wherein the commercial product is Google Earth.

12. The method of claim 1, wherein the ground truth data is in-situ data for the reference parcel of land.

13. The method of claim 1, wherein ground truthing generates a 2D construct of the reference parcel of land.

14. The method of claim 1, wherein ground truthing generates a 3D construct of at least one tree in the reference parcel of land.

15. The method of claim 14, wherein ground truthing determines at least one metric selected from the group consisting of: biomass, leaf area index, and carbon storage.

16. The method of claim 1, further comprising monitoring a target parcel of land by:
obtaining a second remotely sensed dataset, wherein the second remotely sensed dataset is obtained for the target parcel of land; and
identifying a metric in the second parcel of land, wherein the metric is selected from the group consisting of: total canopy cover, biomass, leaf area index, and carbon storage.

17. The method of claim 16, further comprising:
obtaining a third remotely sensed dataset, wherein the third remotely sensed dataset is obtained for the target parcel of land, wherein the third remotely sensed dataset is obtained at a different time than the remotely sensed dataset; and
identifying a change in the target parcel of land.

18. The method of claim 16, wherein monitoring a target parcel of land further comprises harmonizing the second remotely sensed dataset in two dimensions or three dimensions.

19. The method of claim 18, wherein harmonizing comprises at least one of regridding, fishnetting, rasterizing, and interpolating.

20. A method for harmonizing data for a remotely sensed phenomenon having an irregular shape, comprising:
obtaining at least one measurement of a remotely sensed phenomenon; and
constructing a geometric model of the remotely sensed phenomenon based on the at least one measurement.

21. The method of claim 20, wherein the remotely sensed phenomenon is a tree, and wherein the at least one measurement is selected from the group consisting of: tree height, crown base, diameter at breast height, ground, north canopy, east canopy, south canopy, and west canopy.

22. The method of claim 20, wherein the geometric model is a two-dimensional model selected from the group consisting of: a Kabachnik ellipse and a Kabachnik quadrilateral, wherein the Kabachnik ellipse is characterized by two perpendicular and intersecting axes, wherein each axis comprises two arms each extending from the intersection, wherein at least one arm has a different length than the other arms, and wherein the Kabachnik quadrilateral is characterized by two perpendicular and intersecting axes, wherein each axis comprises two arms each extending from the intersection, wherein at least one arm has a different length than the other arms.

23. The method of claim 20, wherein the geometric model is a three-dimensional model selected from the group consisting of: a Kabachnik ellipsoid, a Kabachnik ellipsoid cone, a Kabachnik ellipsoid trapezium, and a Kabachnik ellipsoid cylinder.
